(19) United States
(12) Patent Application Publication
(10) Pub. No.: US 2012/0195367 A1
(43) Pub. Date: Aug. 2, 2012

(54) ADAPTIVE LOOP FILTERING USING TABLES OF FILTER SETS FOR VIDEO CODING

(75) Inventors: Faouzi KOSSENTINI, North Vancouver (CA); Hassen GUERMAZI, Sfax (TN); Nader MAHDI, Sfax (TN); Mohamed Ali Ben AYED, Sfax (TN); Michael HOROWITZ, Austin, TX (US)

(73) Assignee: EBRISK VIDEO INC., North Vancouver (CA)

(21) Appl. No.: 13/350,243

(22) Filed: Jan. 13, 2012

Related U.S. Application Data
(60) Provisional application No. 61/432,634, filed on Jan. 14, 2011.
(60) Provisional application No. 61/432,643, filed on Jan. 14, 2011.
(60) Provisional application No. 61/448,487, filed on Mar. 2, 2011.
(60) Provisional application No. 61/499,088, filed on Jun. 20, 2011.

(51) Int. Cl. H04N 7/26

(52) U.S. Cl. 375/240.02; 375/240.29; 375/E07.027; 375/E07.193

(57) ABSTRACT

Disclosed are adaptive loop filtering techniques for video encoding and/or decoding. For a video unit, the encoder selects a set of predefined filters or generates a set of new filters, and places into the bitstream information identifying the set of predefined filters, or information defining the set of new filters. The set of filters may be used for loop filtering of at least one of the reconstructed samples of the video unit. At the decoder, a set of filters may be obtained by, decoding an index that identifies a set of predefined filters, or by decoding information related to a set of new filters. The obtained set of filters may be used for loop filtering of at least one decoded and reconstructed sample of the video unit.

### CROSS-REFERENCE TO RELATED APPLICATIONS

This application claims priority from each of U.S. Provisional Patent Application Ser. No. 61/432,634, filed Jan. 14, 2011, entitled “ADAPTIVE LOOP FILTERING USING TABLES OF FILTER SETS FOR VIDEO CODING”, U.S. Provisional Patent Application Ser. No. 61/432,643, filed Jan. 14, 2011, entitled “ADAPTIVE LOOP FILTERING USING MULTIPLE FILTER SHAPES”, U.S. Provisional Patent Application Ser. No. 61/448,487, filed Mar. 2, 2011, entitled “ADAPTIVE LOOP FILTERING USING MULTIPLE FILTER SHAPES”, and U.S. Provisional Patent Application Ser. No. 61/499,088, filed Jun. 20, 2011, entitled “SLICE- AND CODING UNIT-BASED ADAPTIVE LOOP FILTERING OF CHROMINANCE SAMPLES”; the entire contents of all four applications is herein incorporated by reference.

### FIELD

Embodiments of the invention relate to video compression, and more specifically, to adaptive loop filtering techniques using a plurality of filter sets in the context of video encoding and/or decoding.

### BACKGROUND

Digital video capabilities can be incorporated into a wide range of devices, including digital televisions, digital direct broadcast systems, wireless broadcast systems, personal digital assistants (PDAs), laptop or desktop computers, video cameras, digital recording devices, video gaming devices, video game consoles, cellular or satellite radio telephones, and the like. Digital video devices may implement video compression techniques, such as those described in standards like MPEG-2, MPEG-4, both available from the International Organization for Standardization (ISO), 1, ch. De la Voie-Creuse, Case postale 56, CH 1211 Geneva 20, Switzerland, or www.iso.org, or ITU-T H.264/MPEG-4 Part 10 Advanced Video Coding (“AVC”), available from the International Telecommunication Union (“ITU”), Place de Nations, CH-1211 Geneva 20, Switzerland, or www.itu.int, each of which is incorporated herein in its entirety, or according to other standard or non-standard specifications, to encode and/or decode digital video information efficiently. Still other compression techniques may be developed in the future or are presently under development. For example, a new video compression standard known as HEVC/H.265 is under development in the JCT-VC committee. One HEVC/H.265 working draft is set out in “Wiegand et. al., “WD3: Working Draft 3 of High-Efficiency Video Coding, JCT-VC-E603”, March 2011, henceforth referred to as “WD3” and incorporated herein by reference in its entirety.

A video encoder can receive uncoded video information for processing in any suitable format, which may be a digital format conforming to ITU-R BT 601 (available from the International Telecommunications Union, Place de Nations, 1211 Geneva 20, Switzerland, www.itu.int, and which is incorporated herein by reference in its entirety) or in some other digital format. The uncoded video may be organized both spatially into pixel values arranged in one or more two-dimensional matrices, as well as temporally in a series of uncoded pictures, with each uncoded picture comprising one or more of the above-mentioned one or more two-dimensional matrices of pixel values. Further, each pixel may comprise a number of separate components used, for example, to represent color in digital formats. One common format for uncoded video that is input to a video encoder has, for each group of four pixels, four luminance samples which contain information regarding the brightness/lightness or darkness of the pixels, and two chrominance samples which contain color information (e.g., YCrCb 4:2:0).

One function of video encoders is to translate or otherwise process uncoded pictures into a bitstream, packet stream, NAL unit stream, or other suitable transmission or storage format (all referred to as “bitstream” henceforth), with goals such as reducing the amount of redundancy encoded into the bitstream, decreasing (on average) the number of bits per coded picture, increasing the resilience of the bitstream to suppress bit errors or packet erasures that may occur during transmission (collectively known as “error resilience”), or other application-specific goals. Embodiments of the present invention provide for at least one of the removal or reduction of redundancy, a procedure also known as compression.

One function of video decoders is to receive as its input a coded video in the form of a bitstream that may have been produced by a video encoder conforming to the same video compression standard. The video decoder then translates or otherwise processes the received coded bitstream into uncoded video information that may be displayed, stored, or otherwise handled.

Both video encoders and video decoders may be implemented using hardware and/or software options, including combinations of both hardware and software. Implementations of either or both may include the use of programmable hardware components such as general purpose central processing units (CPUs), such as found in personal computers (PCs), embedded processors, graphic card processors, digital signal processors (DSPs), field-programmable gate arrays (FPGAs), or others. To implement at least parts of the video encoding or decoding, instructions may be needed, and those instructions may be stored and distributed using a computer readable media. Computer readable media choices include compact-disk read-only memory (CD-ROM), Digital Versatile Disk read-only memory (DVD-ROM), memory stick, embedded ROM, or others.

Video compression and decompression refer to certain operations performed in a video encoder and/or decoder. A video decoder may perform all, or a subset of, the inverse operations of the encoding operations. Unless otherwise noted, techniques of video decoding described here are intended also to encompass the inverse of the described video encoding techniques (namely associated video decoding techniques), and vice versa.

Video compression techniques may perform spatial prediction and/or temporal prediction so as to reduce or remove redundancy inherent in video sequences. One class of video compression techniques utilized by or in relation to the aforementioned video coding standards is known as “intra coding”. Intra coding can make use of spatial prediction so as to reduce or remove spatial redundancy in video blocks within a given video unit, such as a video picture, but which may also represent less than a whole video picture (e.g., a slice, macroblock in H.264, or coding unit in WD3).

A second class of video compression techniques is known as inter coding. Inter coding may utilize temporal prediction from one or more reference pictures to reduce or remove redundancy between (possibly motion compensated) blocks of a video sequence. Within the present context, a block may consist of a two-dimensional matrix of sample values taken from an uncoded picture within a video stream, which may therefore be smaller than the uncoded picture. In H.264, for example, block sizes may include 16×16, 16×8, 8×8, 8×4, and 4×4.

For inter coding, a video encoder can perform motion estimation and/or compensation to identify prediction blocks that closely match blocks in a video unit to be encoded. Based on the identified prediction blocks, the video encoder may generate motion vectors indicating the relative displacements between the to-be-coded blocks and the prediction blocks. The difference between the motion compensated (i.e., prediction) blocks and the original blocks forms residual information that can be compressed using techniques such as spatial frequency transformation (e.g., through a discrete cosine transformation), quantization of the resulting transform coefficients, and entropy coding of the quantized coefficients. Accordingly, an inter-coded block may be expressed as a combination of motion vector(s) and residual information.

Quantization of data carried out during video compression, for example, quantization of the transformed coefficients of the residual information, may cause reconstructed sample values to differ from their corresponding sample values of the original picture. This loss of information affects negatively, among other things, the natural smoothness of the video pictures, which can yield a degradation of the quality of the reconstructed video sequences. Such degradation can be mitigated by loop filtering.

In the following, the term “loop filtering” may be used (unless context specifically indicates otherwise) in reference to spatial filtering of samples that is performed “in the loop”, which implies that the filtered sample values of a given reconstructed picture can be used for future prediction in subsequent pictures in the video stream. Because the filtered values are used for prediction, the encoder and decoder may need to employ the same loop filtering mechanisms (at least to the point where identical results are obtained by the same input signal for all encoder and decoder implementations), yielding identical filtering results and thereby avoiding drift. Therefore, loop filtering techniques will generally need to be specified in a video compression standard or, alternatively, through appropriate syntax added to the bitstream.

In some video coding standards, loop filtering is applied to the reconstructed samples to reduce the error between the values of the samples of the decoded pictures and the values of corresponding samples of the original picture. In H.264, for example, an adaptive de-blocking loop filtering technique that employs a bank of fixed low-pass filters is utilized to alleviate blocking artifacts. These low-pass de-blocking filters are optimized for a smooth picture model, which may not always be appropriate to the video pictures being encoded. For example, a video picture may contain singularities, such as edges and textures, which may not be processed correctly with the low-pass de-blocking filters optimized for smooth pictures. Moreover, the low-pass de-blocking filters in H.264 do not retain frequency-selective properties, nor do they always demonstrate the ability to suppress quantization noise effectively. However, it has been shown that one can reduce the quantization noise substantially and improve the coding efficiency significantly by applying loop filters not specifically targeting deblocking, for example, Wiener filters, which may perform effectively, or in some cases even near-optimally, for pictures that have been degraded by Gaussian noise, blurring and other (similar) types of distortion.

Many techniques in the area of loop filtering have been attempted since the ratification of the first version of H.264.

For example, in Steffen Wittmann and Thomas Wedi, “Post-filter SEI message for 4:4:4 coding,” ISO/IEC JTC1/SC29/WG11 and ITU-T SG16 Q.6, JVT-S030r1, Geneva, CH, 31 March-7 April, 2006, which is incorporated herein by reference in its entirety, a form of adaptive post-filtering was proposed for use, in addition to de-blocking filtering, to reduce quantization errors inside individual blocks. The proposed approach involved application of an adaptive Wiener filter to the inner sample values of such individual blocks. Either the coefficients of the adaptive Wiener filter, or else the correlation coefficients utilized for the design of the adaptive Wiener filter, are made available to the decoder for their possible use in post-processing of the decoded pictures before displaying such pictures.

While the above technique attempted by Wittmann and Wedi may somewhat improve the quality of reconstructed video pictures, one associated disadvantage with their approach is that only the to-be-displayed pictures would be subjected to post-filtering. Re-use of Wiener-filtered pictures as reference pictures for further processing, such as in predictive coding, was generally disallowed. This restriction on the use of Wiener-filtered samples can limit, in some cases substantially, any resulting improvement in video quality because predictively coded pictures, by still referring to non Wiener-filtered samples, could re-introduce some of the artifacts the Wiener filter may have removed in the to-be-displayed picture. Another potential disadvantage is that even if the quality of a post-filtered picture is not better than that of the corresponding decoded picture in some areas, the post-filtered picture is still used, yielding an overall reduction in reproduced video quality for some sequences such as some sports sequences.

Another approach to loop filtering was proposed in T. Chujoh, N. Wada, G. Yasuda, “Quadtree-based adaptive loop filter,” ITU-T Q.6/SG16 VCEG, COM 16-C 181-E, Geneva, January 2009, which is incorporated herein by reference in its entirety. Their approach, referred to as Quadtree-based Adaptive Loop Filtering (QALF), involved an adaptive loop filtering technique (i.e., one that performs filtering inside the coding loop). According to QALF, a quadtree block partitioning algorithm is applied to a decoded picture, yielding variable-size luminance blocks with associated bits. The values of these bits indicate whether each of the luminance blocks is to be filtered using one of three (5×5, 7×7, and 9×9) diamond-shaped symmetric filters.

The QALF technique was modified in Marta Karczewicz, Peisong Chen, Rajan Joshi, Xianglin Wang, Wei-Jung Chien, Rahul Panchal, “Video coding technology proposal by Qualcomm Inc”, ITU-T Q.6/SG16, JCTVC-A121, Dresden, DE, 15-23 April, 2010, which is incorporated herein by reference in its entirety. Rather than a single filter of each dimension (e.g., 5×5, 7×7, and 9×9), in the modified QALF technique, it was proposed to allow the use of a set of different filters for each dimension. The set of filters is made available to the decoder for each picture or a group of pictures (GOP). Whenever the QALF partitioning map indicates that a decoded luminance block is to be filtered, for each pixel, a specific filter from the set of filters is selected that minimizes the value of a sum-modified Laplacian measure. Moreover, when a decoded luminance block is to be filtered, a 5×5 two-dimensional non-separable filter is applied to the samples of the corresponding (decoded) chrominance blocks.

While the above techniques can improve the video quality, one associated disadvantage is that the available filters are of only a single, fixed shape. In most cases, diamond-shaped filters are employed. This restriction on the shape of the filters can limit, in some cases substantially, the improvement in video quality for some video sequences. This limitation can also require the use of a large number of coefficients, which can be costly in terms of both side information and number of computations. For example, in order to specify 16 different 9×9 diamond-shaped symmetric filters, 336 coefficients are required. Moreover, the use of a 9×9 diamond-shaped filter requires 21 separate multiplication operations and 42 separate addition operations per filtered sample at the encoder/decoder (assuming the use of a symmetric filter as described below).

A need therefore exists for an improved method and system for adaptive loop filtering in the context of video encoding and/or decoding. Accordingly, a solution that addresses, at least in part, the above and other shortcomings is desired.

### SUMMARY

Embodiments of the present invention provide method(s) and system(s) for adaptive loop filtering of reconstructed video pictures during the encoding/decoding of digital video data.

In one broad aspect, there is provided a method for video encoding. The method may include, in respect of at least one video unit, selecting either (i) a set of predefined filters from among sets of predefined filters stored in a filter set table or (ii) a set of newly generated filters, and applying at least one filter of the selected set of filters to at least one reconstructed sample of the video unit.

In another broad aspect, there is provided a non-transitory computer readable media having computer executable instructions stored thereon for programming one or more processors to perform a method for video encoding. The method may include, in respect of at least one video unit, selecting either (i) a set of predefined filters from among sets of predefined filters stored in a filter set table or (ii) a set of newly generated filters, and applying at least one filter of the selected set of filters to at least one reconstructed sample of the video unit.

In some embodiments, according to either of the above two aspects, the set of predefined filters may include a set of default filters.

In some embodiments, according to either of the above two aspects, the set of predefined filters may include a set of cached filters.

In some embodiments, according to either of the above two aspects, the method may further include encoding a reference to an entry in the filter set table within a video unit header associated with the video unit. In some cases, the reference to the entry in the filter set table is a parameter set reference. In some cases, the video unit header is a slice header. In some cases, the filter set table is distributed throughout a plurality of parameter sets stored in a parameter set table.

In some embodiments, according to either of the above two aspects, the set of newly generated filters is encoded as at least a part of a parameter set.

In some embodiments, according to either of the above two aspects, the set of newly generated filters is encoded in at least a part of a video unit header.

In some embodiments, according to either of the above two aspects, at least one of the set of predefined filters or the set of newly generated filters includes only one filter.

In yet another broad aspect, there is provided a method for video decoding. The method may include, in respect of at least one video unit, receiving a reference to either (i) a set of predefined filters or (ii) a set of newly generated filters, and applying at least one filter of the referenced set of filters to at least one decoded or reconstructed sample of the video unit.

In yet another broad aspect, there is provided a non-transitory computer readable media having computer executable instructions stored thereon for programming one or more processors to perform a method for video decoding. The method may include, in respect of at least one video unit, receiving a reference to either (i) a set of predefined filters or (ii) a set of newly generated filters, and applying at least one filter of the referenced set of filters to at least one decoded or reconstructed sample of the video unit.

In some embodiments, according to either of the above two aspects, the set of predefined filters may include a set of default filters.

In some embodiments, according to either of the above two aspects, the set of predefined filters may include a set of cached filters.

In some embodiments, according to either of the above two aspects, the reference to a set of predefined filters is a parameter set reference from a slice header.

In some embodiments, according to either of the above two aspects, the method may further include activating a parameter set comprising the referenced set of predefined filters.

In some embodiments, according to either of the above two aspects, the set of newly generated filters is received as part of a parameter set.

In some embodiments, according to either of the above two aspects, the set of newly generated filters is received as part of a video unit header.

In some embodiments, according to either of the above two aspects, at least one of the set of predefined filters or the set of newly generated filters includes only one filter.

### BRIEF DESCRIPTION OF THE DRAWINGS

Further features and advantages of the embodiments of the present invention will become apparent from the following detailed description, taken in combination with the appended drawings, in which:

FIG. 1 is a diagram illustrating a video codec with a de-blocking loop filter and an adaptive loop filter in accordance with an embodiment of the invention;

FIG. 2 shows an exemplary filter set table in accordance with an embodiment of the invention;

FIG. 3 shows an exemplary filter set transmission using a video unit header;

FIG. 4 shows a flow diagram illustrating an example coding of coefficients of each filter of a set of newly-generated filters in accordance with an embodiment of the invention;

FIG. 5 shows a flow diagram illustrating an example selection of a set of filters in accordance with an embodiment of the present invention;

FIG. 6 shows flow diagrams illustrating an example signaling of a selected sets of filters in accordance with an embodiment of the invention; and,

FIG. 7 is a block diagram illustrating a data processing system (e.g., a personal computer or “PC”) based implementation in accordance with an embodiment of the invention.

It will be noted that throughout the appended drawings, like features are identified by like reference numerals.

### DETAILED DESCRIPTION EMBODIMENTS

In the following description, details are set forth to provide an understanding of the invention. In some instances, certain software, circuits, structures, and methods have not been described or shown in detail in order not to obscure the invention. The term “data processing system” is used herein to refer to any machine for processing data, including the computer systems, wireless devices, and network arrangements described herein. Embodiments of the present invention may be implemented in any computer programming language provided that the operating system of the data processing system provides the facilities that may support the requirements of the present invention. Embodiments of the present invention may also be implemented in hardware or in a combination of hardware and software.

At least some embodiments of the present invention relate to adaptive loop filtering of reconstructed pictures in the context of video encoding and/or decoding. The term “loop filtering” may be used to indicate a type of filtering that can be applied to the reconstructed pictures within the coding loop, with the effect that the filtered (reconstructed) pictures are saved and may be used for the reconstruction of other pictures in a video sequence.

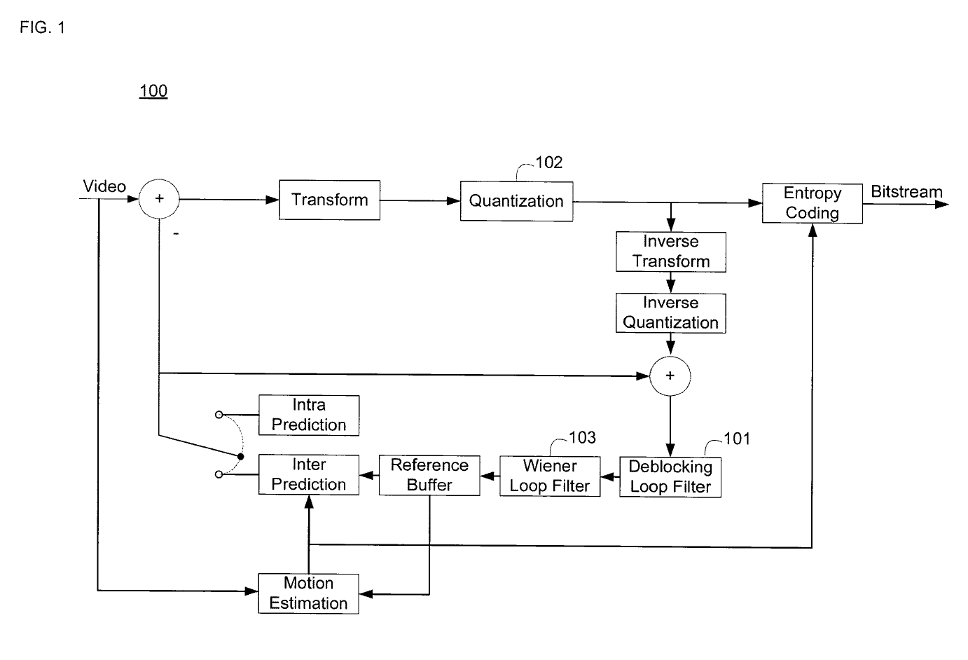

FIG. 1 shows block diagram of a video encoder 100 that is operable to encode video sequences that are formatted into video units. The encoder 100 includes a de-blocking loop filter 101 and an adaptive loop filter 103, located in a filtering loop of the video encoder 100, in accordance with an embodiment of the invention. The de-blocking filter 101 may be configured to adaptively applying low-pass filters to block edges and, in doing so, the de-blocking filter 101 can improve both the subjective and objective quality of the video being encoded in the encoder 100. Subjective quality may refer to quality of the reconstructed video or picture as perceived by an average human observer and can be measured, for example, by following ITU-R Recommendation BT.500. Objective quality may refer to any determination of video quality that can be expressed by a mathematic model based generally on a comparison between the original picture and a corresponding picture reconstructed from the bitstream. For example; one frequently used objective quality metric is known as Peak Signal-to-Noise Ratio (PSNR).

In some embodiments, the de-blocking loop filter 101 operates by performing an analysis of samples located around a block boundary and then applying different filter coefficients and/or different filter architectures (e.g., number of taps, Finite Impulse Response (FIR)/Infinite Impulse Response (IIR), as discussed below) so as to adaptively attenuate small intensity differences in the samples which are attributable to quantization noise, while preserving intensity differences that may pertain to the actual video content being encoded.

Such blocking artifacts that may be removed by the de-blocking loop filter 101 are not the only artifacts present in compressed video and observable after reconstruction. For example, coarse quantization, which may be introduced by the selection of a numerically high quantizer value in the quantization module 102 based on compression requirements, may contribute to other artifacts such as ringing, edge distortion or texture corruption, being introduced into the compressed video. The low-pass filters adaptively employed by the de-blocking loop filter 101 for de-blocking may assume a smooth image model, which may make such low-pass filters perform sub-optimally for de-noising image singularities such as edges or textures. As used herein throughout, the term “smooth image model” may be used in reference to video pictures whose image content tends to exhibit relatively low frequency spatial variation and to be relatively free of high-contrast transitions, edges or other similar singularities.

Accordingly, the video encoder 100 may include an additional filter cascaded together with the de-blocking loop filter 101 and used to at least partially compensate for the potential sub-optimal performance of the low-pass filters configured within the de-blocking loop filter 101. For example, as seen in FIG. 1, the video encoder 100 may further include loop filter 103, which can be a Wiener filter, and which is configured to filter at least the inner sample values of some blocks of a video unit and thereby reduce or even eliminate the quantization errors inherent in such blocks.

As used in the present context, the term “video unit” may be defined so as to represent any syntactical unit of a video sequence that covers, at least, the smallest spatial area to which spatial filtering can be applied. According to this definition, for example, a video unit may encompass the spatial area covered by elements that in H.264 were referred to as “blocks”. However, within the present context, a video unit can also be much larger than such blocks. For example, in some embodiments, a video unit may be a macroblock, or (as referred to in WD3) a Coded Tree Block (CTB) or a Largest Coding Unit (LCU), or a slice, or even a whole video picture. Alternatively, a video may be a group of non-contiguous macroblocks, such as a slice group (as referred to in H.264). Alternatively, a video unit may be a “column” or “tile”, for example, as described in co-pending U.S. patent application Ser. No. 13/336,675, filed Dec. 23, 2011, entitled “METHOD AND SYSTEM FOR PICTURE SEGMENTATION USING COLUMNS”, which is incorporated herein by reference in its entirety. Henceforth, in order to simplify the description, unless noted otherwise it will be assumed that each use of the term “video unit” refers to an entire video picture. Thus, by this assumption, the spatial area filtered by loop filter 103 using filters of the same filter set will equate to a picture.

In some embodiments, one filter set may be used in the encoding/decoding of the video unit and such filter set can comprise one or more different filters, as the case may be. The filter(s) included within the utilized filter set may be separable or non-separable. Moreover, the filter(s) can be configured as either IIR or FIR filters, or some other general class of filter. Each filters within a given filter set may also have the same general shape and/or the same number of coefficients, such that each different filter set may be defined according to a different filter shape and/or different number of coefficients.

In some embodiments, filter sets used in the encoding/decoding can be newly generated at the encoder side for subsequent use on the decoder side. As used in the present context, a “newly generated filter set” may reference a filter set in which at least one of the filter(s) comprising the filter set is computed (in some cases content-adaptively) based on, for example, sample values of the video unit, or alternatively sample values of all or a subset of samples of the video picture in which the video unit has been defined. One possible approach to filter generation in accordance with embodiments is described in more detail below. The newly generated filter set may be inserted into a bitstream generated by the encoder and can be made available to a decoder for example through transmission, or can be conveyed to the decoder out of band; both approaches are described in greater detail below. In some cases, encoder(s) and/or decoder(s) may be configured so that a newly generated filter set will override a cached filter set (described next), either in part or in full.

In some embodiments, one or more default filter sets may also be utilized in encoder(s) and/or decoder(s). As used in the present context, a “default filter set” may reference a filter set whose filter parameters are known a priori between the encoder and decoder, i.e., without any filter information having been communicated between encoder and decoder, for example, in a transmitted bitstream or out of band. One example of a default filter set can be a filter set that is mandated as part of a video compression standard with which the encoder and decoder are designed to comply. In such cases, where forming part of a video compression standard, a default filter set may be “hard coded” within compliant implementations of the encoder and decoder. However, embodiments of the present embodiment are not limited only to default filter sets that form part of a specification, and other forms or types of default filters sets may be defined and utilized as well. For example, a default filter set may also be one that is shared between the encoder and decoder by mechanisms such as a call control protocol in a video conference or a session announcement in an IPTV program. Another example of a default filter set is one that is known to be well-performing in a certain application space and therefore used, for example, by vendor agreement without formal standardization within that application space.

In some embodiments, one or more cached filter sets may also be utilized in encoder(s) and/or decoder(s). As used in the present context, a “cached filter set” may reference a filter set that has previously been generated and communicated from the encoder to the decoder, either in the bitstream or out of band. The received filter set may be “cached” by the decoder and thereafter may be referenced within the bitstream so as to instruct use of the cached filter set by the decoder. In this regard, reference within the bitstream to a cached filter may function similar to reference within the bitstream to a default filter set because, in either case, such reference may provide sufficient information for the decoder to operate. A cached filter set can be a filter set that was newly generated by the encoder during the coding of an earlier video unit and is known between the encoder and decoder. For example, the encoder and decoder may have temporarily stored the newly generated filter set for use subsequent to the encoding or decoding of the video unit in which context the new filter set was generated (i.e., for use in decoding subsequent video units). Temporary storage of data or other information (such as a filter set) for later use is commonly known as caching, and the storage module used for this purpose is commonly known as a cache.

In some embodiments, encoders may be configured to encode filter set-related information into a bitstream (as generated by the encoder for use in the decoder) with use of at least two data structures. One such data structure may include information that is formatted so as to provide reference to a given filter set that is to be used by a decoder to filter at least one video unit. A second data structure may include information that is formatted so as to facilitate management of one or more sets of filters and may include, for example, instructions for adding or replacing new filter sets or parts thereof, removal of cached filter sets, and so on. Within embodiments, these two data structures may be generally useful for filter referencing and filter set management, respectively. In the following, such aspects of embodiments will be described in turn.

In some embodiments, the encoder and decoder may each be configured to maintain a table of filter sets, which table may contain one or more entries to represent all sets of predefined filters that have been made known between the encoder and decode. The table of filter sets may have finite size, such as one, two, four, or eight entries. Each entry in the table may provide a complete description of a given filter set and, for example, may include information relating to the type of the filters with each filter set, the shape, size or other dimensional information of the filters within the filter set, coefficients for the various filters included within the filter set, and so on.

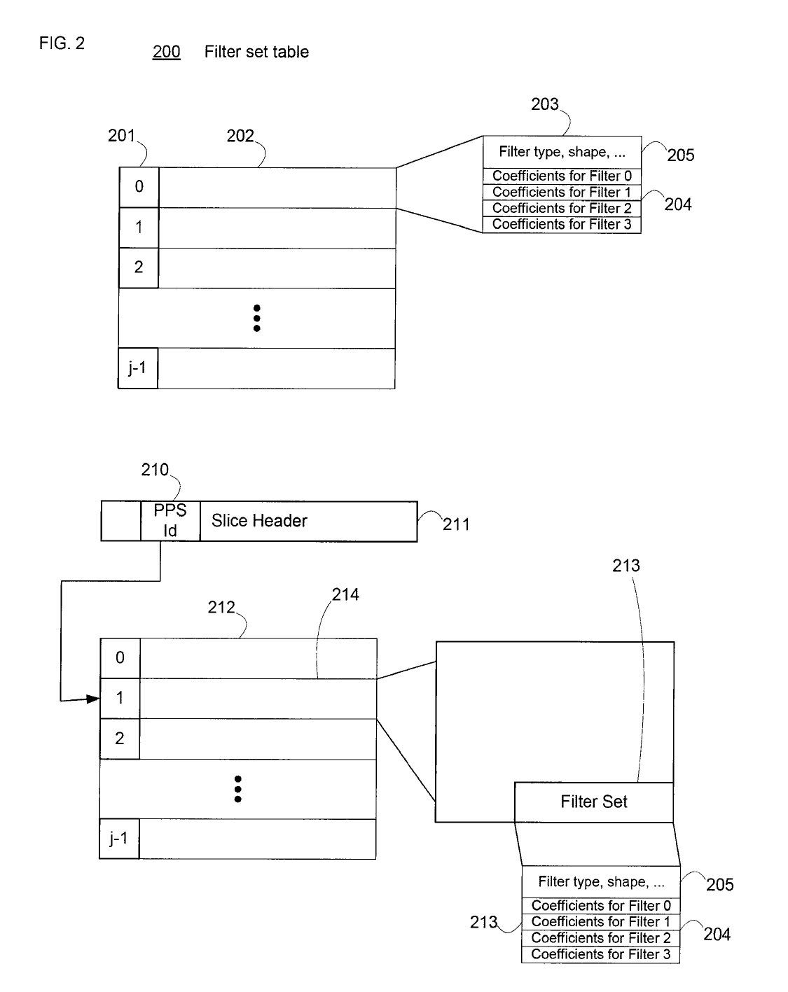

Referring now to FIG. 2, there is shown an exemplary table of filter sets 200 in accordance with an embodiment of the invention. The table of filter sets 200 may be arranged into j rows and two columns. In this configuration, column 201 may include j index values (e.g., from 0 to j-1), each of which being associated with and used to refer to a different entry 203 contained with column 202 of the table 200. Each entry 203 may contain information relating to and completely specifying a different set of filters 203. Each set of filters specified by an entry 203 may contain one or more filters, and each entry 203 may contain coefficient information 204 for each included filter, as well as control information 205 specifying the type of the filter(s), the shape and/or size of the filter(s), and similar information.

In some embodiments, reference to a filter set can be encoded using integer format. However, depending on the context and/or application, different reference formats may be convenient. For example, in some cases, the filter references may advantageously be encoded using whichever entropy coding format is used within a given video compression standard (e.g., CABAC in the High Profile of H.264). In some cases, reference to a filter set may be encoded using a Boolean format, for example, where there are only two possible filter sets to reference. The format used for such filter set references within the bitstream may correlate to the index values stored within column 201 of table 200 to thereby provided access into the table 200 according to the encoded reference.

Still referring to FIG. 2, the table of cached or predefined filter sets can be utilized over a plurality of different parameter sets in accordance with embodiment of the invention. The term “parameter set” is defined in H.264 or WD3 and, within the present context, may be used in reference to a data structure or syntax that contains information relating to more than one slice (i.e., in contrast to a slice header, which may contain only information that is relevant to a single slice and not other slices).

Accordingly, in some embodiments, each parameter set may be defined so as to include an integer number, for example, which corresponds to a stored filter set. In this case, a syntax element 210 may be inserted into header 211 within the bitstream which has been adapted to contain parameter set references. The syntax element 210 may represent an integer index value that addresses an entry 214 in a parameter set table 212. For example, the parameter set reference mechanism described in H.264 and WD3 may be utilized for referencing a filter set from within a video unit, in which case the header 211 may be a slice header, the parameter set table 212 may be a picture parameter set table or adaptation parameter set table, and each entry 214 in table 212 may represent a picture parameter set, as defined in H.264 and WD3.

In the example shown in FIG. 2, each entry 214 includes only one filter set 213, and, therefore, filter sets are addressed within the table 212 indirectly based on a parameter set reference (i.e., 210 references given entry 214). However, in some embodiments, a parameter set may contain more than one filter set. In such cases, the syntax element 210 may be modified, or alternatively an additional syntax element in the same or another NAL unit header (e.g., header 211 or the like) may be included, so as to reference not just a given parameter set (i.e., a particular entry 214 within table 212), but also the appropriate filter set 213 stored within that parameter set (not shown).

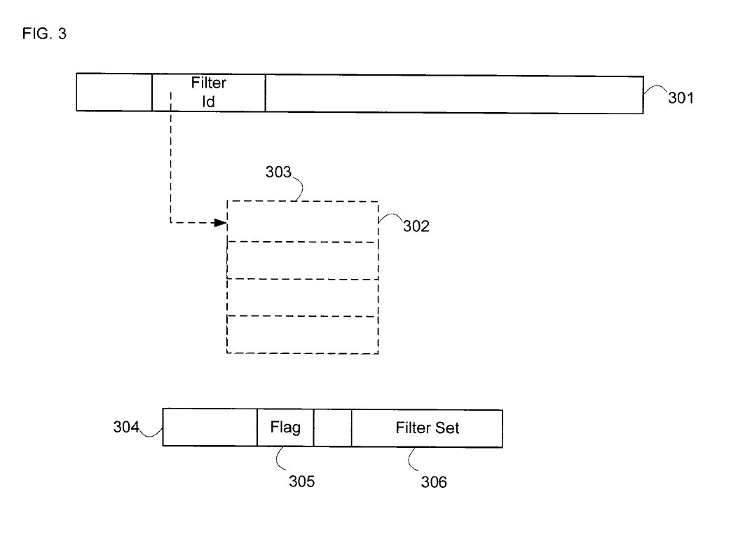

Referring now to FIG. 3, a filter set can also be directly referenced (i.e., without explicitly addressing as a table entry by coding a table entry number), in addition to the referencing mechanism described in the context of FIG. 2, in accordance with embodiments of the invention. For example, such direct filter set reference may be useful for filter sets, such as newly generated filter sets, which are stored in cache or other addressed memory within a decoder.

As seen in FIG. 3, for example, reference may be made within the header of a first (large) video unit 301, such as a picture or a slice, to a cached or pre-defined filter set 302 in a filter table 303, as described above in the context of FIG. 2. The reference can be using any of the aforementioned referencing mechanisms described in the context of FIG. 2. A reference path into the filter table 303 can be activated within the decoder upon decoding of the slice header, and is shown in FIG. 3 by dashed lines. Such activation may occur before decoding of the first LCU/macroblock of a slice or picture.

In some embodiments, a second video unit header 304 of a second (small) video unit may also be utilized within the same first (large) video unit. Such approach may differ in at least some respects from the approach described above in the context of FIG. 2. For example, the second video unit header 304 may be the macroblock or an LCU header located in the picture or slice data to which the header of video unit 301 belongs. In some cases, the second video unit header 304 may contain a use_new_flag flag 305 that is Boolean valued. When cleared (i.e., “zero” or “FALSE” valued), for example, the flag 305 may indicated that the pre-defined table entry identified by the LCU header is to be used and, when set (i.e., “one” or “TRUE” valued), that the newly generated filter set is to be used.

The result of such an operation can be that the filter 302 will be used for all small video units in the large video unit which have the use_new_{'}flag flag 305 cleared. However, for those small video units in which the use_new_flag flag 305 is set, the filter set 306 will be used.

In some cases, though not necessarily in all cases, the selection of a newly generated filter set as indicated by the use_new_flag flag 305 can result in the cached filter set 302 being overwritten. For example, where a filter table entry 302 refers to a default filter set, overwriting of the default filter set upon selection of a newly generated filter set may not be possible. Such a failsafe mechanism to prevent overwriting of default filters may effectively reduce coding overhead in the macroblock or LCU header and allow for flexible updates of newly defined filters, while still preserving the option of having multiple pre-defined or cached filters per picture that can be addressed, for example, through the above-described parameter set referencing mechanism. According to different embodiments, the newly defined filter set 306 may be either part of the second video unit header 304 or else located in other appropriate places in the bitstream.

Having described different possible mechanisms for providing reference to a filter set in embodiments of the invention, description relating broadly to filter set management will not be provided.

So as to enable drift-free decoding, a decoder may be required to maintain a filter set table that, at any given point in time in the decoding of a video sequence, stores identical states as were stored in the filter set table maintained by the encoder at the same instants of time during encoding. In some cases, the filter set table maintained by the encoder may contain additional filter sets not present within the decoder's filter set table, for example because such additional filter sets have not yet been made available to the decoder in the bitstream or out of band. Consequently, it may not be possible for these additional filter sets to be meaningfully referenced, i.e., because the decoder has present no knowledge of the additional filter sets' attributes. Similar behaviour may be observed in parameter sets that are modified on the encoder side before transmission to the decoder side.

In some embodiments, a decoder may be configured to initialize all sets of filters in a filter set table maintained by the decoder, including filters that are not predefined within set(s) of default filters. Initialization may occur when the decoder commences a decoding process or, alternatively, at other points in time (e.g., Independent Decoder Refresh pictures in H.264). Certain advantages may be realized from filter set initialization of this kind In one advantage, encoders not electing to use, or perhaps that are incapable of using, filter set management may still be operable to generate bitstreams that are compliant with a given video compression standard. To achieve this effect, for example, the encoder may include any valid reference into the filter set table within the bitstream on the assumption that sets of default filters are being used. In another advantage, if the bitstream were to contain a reference to a set of filters that had been defined by the encoder, but that definition was lost in transmission, the decoder would still be provided with a set of default filters that would be available for use in filtering. Such failsafe feature in decoders may be useful, for example, in improving error resilience during bitstream transmission. In yet another advantage realize by filter set initialization, resetting sets of filters to a default state at IDRs allows for splicing of bitstream fragments at these points without having to establish the correct filter set states. Still other advantages may be realized.

So as to manage a filter set table, an encoder may require that updates made to a given filter set on the encoder side can be communicated also to the decoder. As mentioned, advantageously, filter set tables can be initialized with sets of default filters.

According to embodiments, a decoder may be configured to receive newly generated filter sets or parts thereof, e.g., which have been generated and transmitted at the encoder side. By definition, default filter sets may be hard-coded within a decoder or otherwise known a prior and, therefore, may not need to be received by the decoder. Also, cached filter sets can be available to a decoder because they had previously been received as newly generated filter sets generated and transmitted from an encoder.

In some embodiments, similar to operation definitions found within H.264 or WD3, decoder information that pertains to more than one slice may be included within a parameter set or alternative data structure, as opposed to being included within a slice header, which generally only contains information relevant to a single slice. In some embodiments, entries in a filter set table may pertain to more than one slice. Therefore, one or more newly generated filter set(s) may be completely new filter sets, but also may be updates to previously generated filter sets that are stored in a filter set table. In either case, the newly generated filter sets may be made available to the decoder as part of an appropriate parameter set within a bitstream generated by an encoder.

In some embodiments, a filter set table can be distributed throughout one or more parameter sets organized into a parameter set table, as already described. In such cases, different filter sets may be allocated to different parameter sets within the parameter set table. If only one filter set is allocated to each parameter set, updates of the filter set table may be achieved according to parameter set update and/or activation protocols, such as those described in H.264 or WD3. For example, a decoder can receive a parameter set NAL unit indicating the entry number of the parameter set, and new parameter set values. Upon reception of the NAL unit, the content can be stored in the parameter set table. In some cases, new content (including any new filters described in the new filter set) will only becomes available for use by the decoder when they are “activated”, which typically occurs when the decoder encounters picture boundaries within a video sequence.

In some embodiments, a decoder may be able to update a filter set table by the encoder making available (i.e., by sending, placing in the bitstream, or other appropriate means) a specification of a set of new filters. The update can be in any format agreed between the encoder and decoder. For example, the update information can be entropy coded, as described later.

In some embodiments, an encoder may be configured to encoder a newly generated filter set, which may then be received by a decoder in a video unit header, such as a picture, slice, macroblock, or LCU header. Immediate activation of the newly generated filter set may occur following receipt of the newly generated filter set, in some cases, for example, in response to control information such as a bit within the header. Within this context, “immediate activation” may refer to use of the newly generated filter set being enabled for the video unit immediately following in the decoding loop. For any purpose, activation of the newly generated filter set may also be delayed by a number of video units. The newly generated filter set received at the decoder can also be stored in a position of the filter set table upon receipt. Again, such action by the decoder may be taken in response to control information such as a bit within the header. For example, the position in the filter set table can be the same position as was “active” before receipt of the video unit header containing the newly generated filter set. For the first video unit header that can contain a newly generated filter set, in relation to which no position in the filter table would have previously been “active, instead the decoder may select a default, e.g., hard-coded position within the filter set table for storage of the first newly generated filter set from the encoder.

In some embodiments, a designated position in a filter set table may be reserved for newly generated parameter sets conveyed as part of a video unit header.

In general, within the described embodiments, the encoder may have self-control to manage the finite resources which have been allocated for storage of filter set table entries. For example, the encoder may implement a First-In, First-Out (FIFO) process so as to purge older sets of cached entries from the filter set table to be overwritten with newer entries generated by the encoder.

In some embodiments, the encoder may be operable to generate a set of filters during the encoding process. In generating a set of filters, the encoder may perform analytical computations and select one or more different filters based on the results of the computation. For example, the encoder may generate a set of filters by minimizing the mean square error between some samples of the original picture and the corresponding samples of the de-blocked picture (which have been processed using different candidate filters from which the encoder makes a selection).

In some embodiments, one or more filters included in a set of newly-generated filters can be encoded, for example, using a three-stage process of quantization, prediction, and entropy coding as described in Y. Vatis, B. Edler, I. Wassermann, D. T. Nguyen, and J. Ostermann, “Coding of Coefficients of two-dimensional non-separable Adaptive Wiener Interpolation Filter”, Proc. VCIP 2005, SPIE Visual Communication & Image Processing, Beijing, China, July 2005, which is incorporated herein by reference in its entirety.

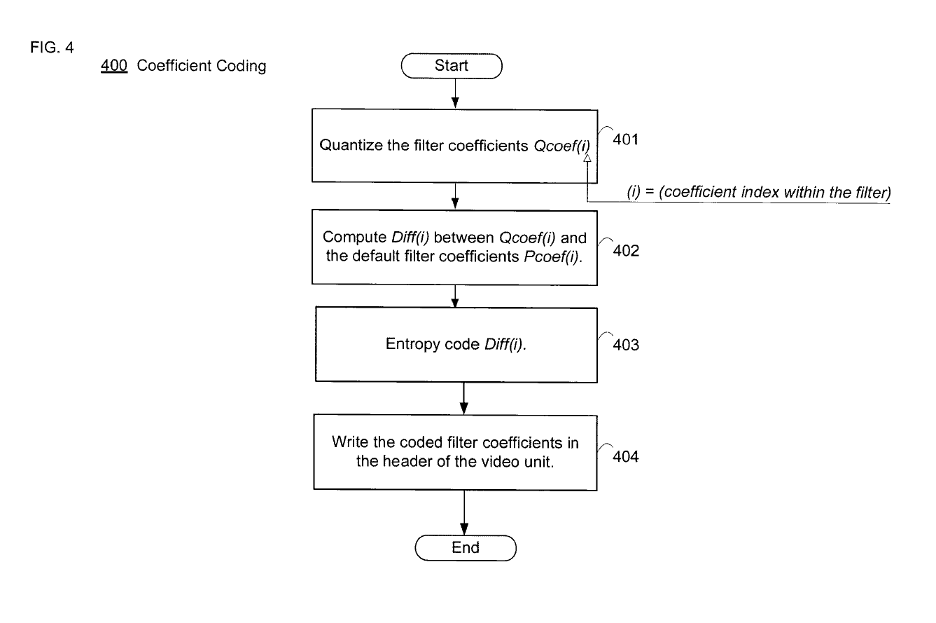

Referring now to FIG. 4, there is shown a flow diagram illustrating an example method 400 for coding the coefficients of each filter in a set of newly-generated filters, in accordance with an embodiment of the invention. The method 400 may be performed, for example, by the loop filter 103 in encoder 100 of FIG. 1 once for each video unit within a video sequence.

According to the method 400, the coefficients of each newly-generated filter are first quantized (401) using suitably chosen quantization factors. For example, different for selecting quantization factors that provide acceptable compromise between filter accuracy and size of the side information may be used for this purpose. The differences between the quantized coefficients and corresponding default filter coefficients are computed (402). The obtained difference values are entropy coded (403) and inserted (404) into the video unit header, parameter set, or other structure used to communicate a newly generated filter to a decoder.

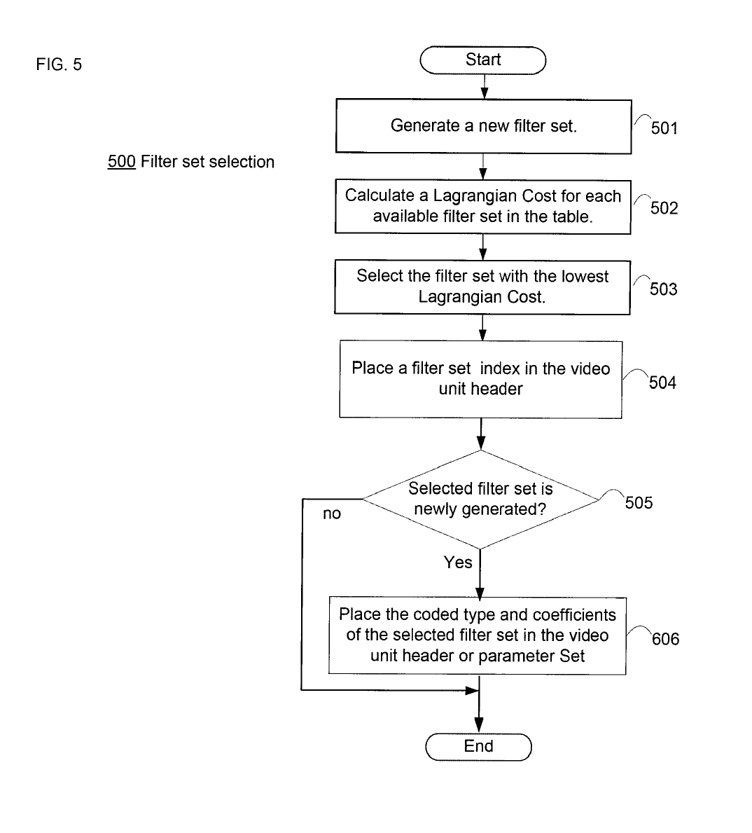

Referring now to FIG. 5, there is shown a flow diagram illustrating an example method 500 for filter set selection in an encoder in accordance with an embodiment of the invention. The method 500 may be performed, for example, by the loop filter 103 in encoder 100 of FIG. 1 once for each video unit in a video sequence. By performing the method 500, the encoder 500 may select a particular filter set for use according to one or more different selection criteria. The selected filter set may be one of a number of sets of predefined filters or, depending on the outcome of the utilized selection criteria, may alternatively be a set of newly-generated filters.

According to the method 500, a set of new filters for each video unit is first generated (501). For each available set of filters (including sets of pre-defined filters and sets of newly generated filters), a Lagrangian cost can be computed (502). In some cases, such computation (502) may take into account any or all of source sample values, filtered sample values, and associated costs for coding each given filter set and/or filter references, as the case may be. Different computation of Lagrangian cost may be possible. For example, the Lagrangian cost may be computed in a rate-distortion sense by defining costs associated with both distortion that occurs due to filtering and bit requirements for coding different filter sets, and which are scaled using a selected multiplier. Thus, the Lagrangian cost may be computed by adding mean squared errors between corresponding samples in the original video unit and the filtered video unit (where each sample of the video unit is filtered using a member of the filter set), and to that sum adding a bias that is a function, through the selected multiplier, of the number of bits required to transmit the filter set and/or filter set references to the decoder. In a particular case, the Lagrangian cost can be computed using the mode-decision-algorithm (Lagrangian) multiplier, although other computations and/or formulations of a suitable Lagrangian multiplier may be possible as well.

The filter set with the lowest computed Lagrangian cost can be selected (503) for use. Such selection (503) may be indicated by inserting (504) a filter set reference (i.e, an index value into a filter set table, which can be a parameter set reference in some cases) into the video unit header.

If a set of newly generated filters was selected (in 503), then the method 500 branches (505) and a specification of the newly generated filter set (i.e., type of filters, coefficients, etc.) is inserted (506) in the video unit header, parameter set, or other syntax structure within the bitstream. Alternatively, the specification of the newly generated filter may be conveyed out of band to the decoder. The resulting bitstream and other information (i.e., out-of-band information) is then made available to the decoder, for example, by transmission from the encoder. At this point, method 500 may end.

If, however, a set of newly generated filter was not selected (in 503), then method 500 may end directly, bypassing (505) the insertion (in 506). In this case, insertion of a filter set specification may not be required due to selection of a default or cached filter set (i.e., which may already be hard-coded into the decoder or stored in cache or other accessible memory).

In many video compression standards, only bitstream syntax and decoder reaction to the bitstream are standardized, leaving many other aspects of video compression non-standardized and susceptible to modification and/or variation. For example, the selection of a particular filter set according to any of the embodiments described herein may be implementation dependent and not part of a standard specification, whereas the syntax and semantics of the data structures or other information used to transmit (i.e., from encoder to decoder) the filter set, or to indicate the particular selection of the set of predefined filters for the video unit, might be part of the standard specification.

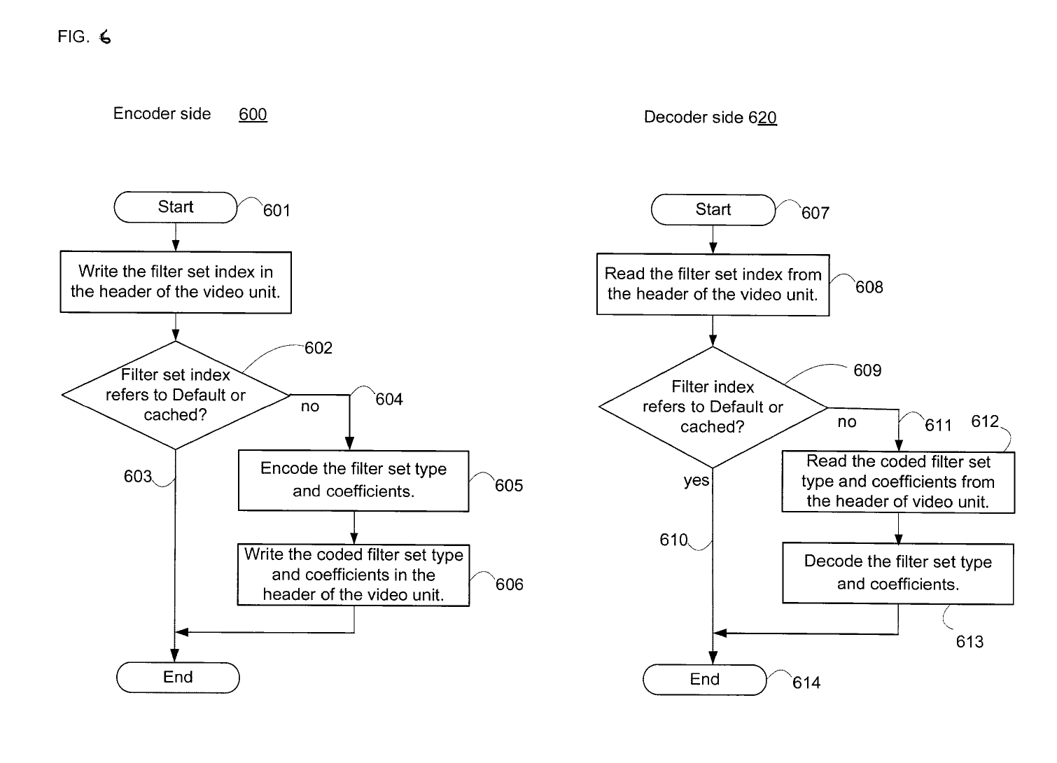

Referring now to FIG. 6, there are shown flow diagrams illustrating example methods for encoder-side and decoder-side operation, in accordance with an embodiment of the invention. More specifically, there is shown a method 600 for encoding a video unit and a method 620 for decoding a video unit. The method 600 may be performed, for example, by the encoder 100 of FIG. 1., while the method 620 may be performed by a decoder that has been configured, according to the described embodiments, for operation in association with the encoder 100. Accordingly, in some embodiments, the video unit decoded according to the method 620 may have been encoded according to the method 600.

On the encoder side, according to the method 600, a video unit header is updated (601) with an index value into a filter set table. If that index value refers (602) to a default or cached filter, then the method 600 may terminate with no further data or information related to a filter set being written to the video unit header (or written elsewhere in the bitstream or transmitted out of band). If this is the case, bitstream generation may proceed (603) as usual. This can involve operations such as motion vector search, motion vector coding and motion compensation of reference picture samples according to the motion vector, calculating a residual using motion compensated reference picture samples and the source samples, transforming the residual, quantization and entropy coding of the quantized transform coefficients.

If, however, the index value refers (602) to a set of newly-generated filters, the encoder may proceed (604) by entropy-encoding (605) the filter type and coefficients associated with the newly-generated filters. For example, such data may be encoded according to any accepted entropy coding mechanism presently in use (in H.264, this might be CA-VLC or CABAC). The encoded data is then written (606) into the video unit header, parameter set, or other appropriate place in the bitstream, or else is communicated to a decoder out of band. Finally, loop-filtered samples may be stored in the reference picture memory (not shown).

On the decoder side, according to the method 620, a state machine or other data processor within a decoder that is configured to interpret the syntax and semantics of coded video sequences, at some point, determines (607) that receipt of data relating to an adaptive loop filter (e.g., loop filter 103 in FIG. 1) is to be expected. This determination may be made through any suitable configuration of the state machine or data processor. The decoder reads and examines (608) a filter set index obtained from the received video unit header. If the obtained filter set index refers (609) to a cached filter set or to default filter set, then decoding (614) (the inverse of the encoding as described above) may proceed (610), without further syntax-based activity, using the default or cached set of filters indicated by the filter set index previously read (in 608).

If, however, the index value does not refer (609) to a default or cached set of filters, indicating that a set of newly-generated filters has been transmitted and is to be expected, the decoder may proceed (609) by fetching (612) filter information such as a filter set type and coefficients from the video unit header, each of which having also been inserted into the bitstream by the encoder. The fetched filter information is entropy-decoded (613) using whatever entropy coding scheme presently in use was utilized by the encoder. At this point, the bitstream-related processing is terminated and the fetched filter set type and coefficients are used for decoding (614) sample data.

In some embodiments, different sets of loop filters may be selected and used based on criteria and/or considerations other than video units. For example, different sets of filters may be used for the different color planes (e.g., as defined in YCrCb 4:2:0 uncompressed video). Accordingly, in some embodiments, more than one filter set table may be defined, with each filter set table designed for a specific criterion other than spatial area, such as a color plane.

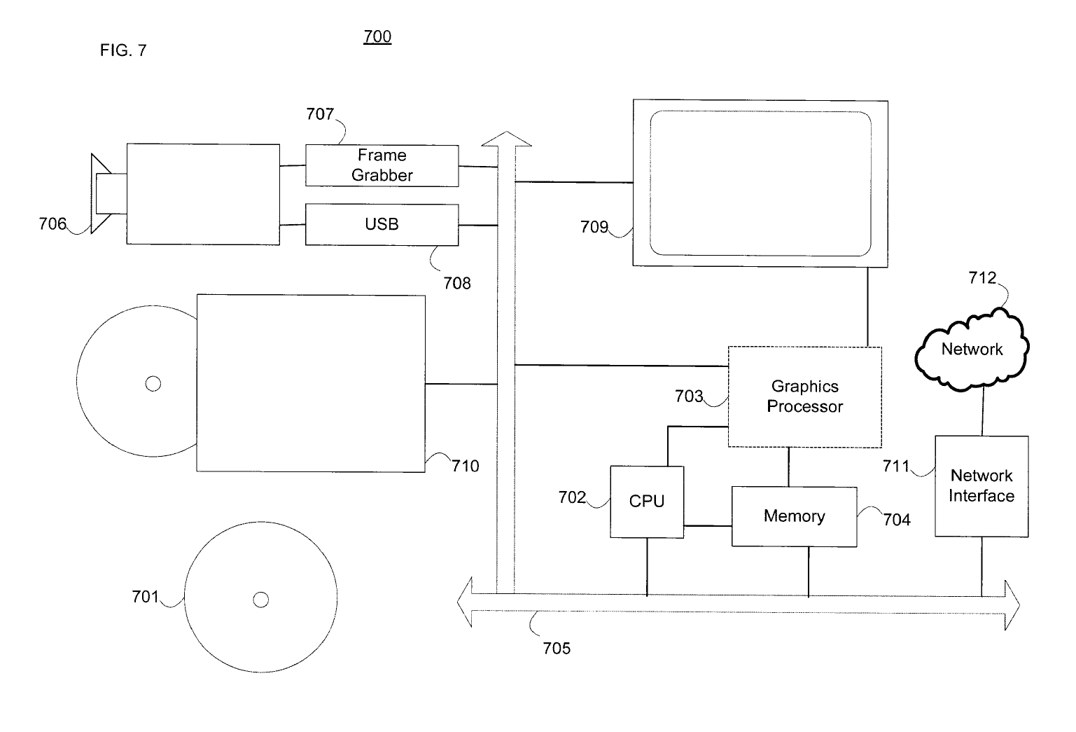

FIG. 7 shows a data processing system (e.g., a personal computer (“PC”)) 700 based implementation in accordance with an embodiment of the invention. Up to this point, for convenience, the disclosure has not related explicitly to possible physical implementations of the encoder and/or decoder in detail. Many different physical implementations based on combinations of software and/or components are possible. For example, in some embodiments, the video encoder(s) and/or decoder(s) may be implemented using custom or gate array integrated circuits, in many cases, for reasons related to cost efficiency and/or power consumption efficiency.

Additionally, software implementations are possible using general purpose processing architectures, as example of which is the data processing systems 700. For example, using a personal computer or similar device (e.g., set-top-box, laptop, mobile device) 700, such an implementation strategy may be possible as described in the following. As shown in FIG. 7, according to the described embodiments, the encoder and/or the decoder for a PC or similar device 700 may be provided in the form of a computer-readable media 701 (e.g., CD-ROM, semiconductor-ROM, memory stick) containing instructions configured to enable a processor 702, alone or in combination with accelerator hardware (e.g., graphics processor) 703, in conjunction with memory 704 coupled to the processor 702 and/or the accelerator hardware 703 to perform the encoding or decoding. The processor 702, memory 704, and accelerator hardware 703 may be coupled to a bus 705 that can be used to deliver the bitstream and the uncompressed video to/from the aforementioned devices. Depending on the application, peripherals for the input/output of the bitstream or the uncompressed video may be coupled to the bus 705. For example, a camera 706 may be attached through a suitable interface, such as a frame grabber 707 or a USB link 708, to the bus 705 for real-time input of uncompressed video. A similar interface can be used for uncompressed video storage devices such as VTRs. Uncompressed video may be output through a display device such as a computer monitor or a TV screen 709. A DVD RW drive, or equivalent (e.g., CD ROM, CD-RW Blue Ray, memory stick) 710 may be used to input and/or output the bitstream. Finally, for real-time transmission over a network 712, a network interface 711 can be used to convey the bitstream and/or uncompressed video, depending on the capacity of the access link to the network 712, and the network 712 itself.

According to various embodiments, the above described method(s) may be implemented by a respective software module. According to other embodiments, the above described method(s) may be implemented by a respective hardware module. According to still other embodiments, the above described method(s) may be implemented by a combination of software and hardware modules.

While the embodiments have, for convenience, been described primarily with reference to an example method, the apparatus discussed above with reference to a data processing system 700 may, according to the described embodiments, be programmed so as to enable the practice of the described method(s). Moreover, an article of manufacture for use with a data processing system 700, such as a pre-recorded storage device or other similar computer readable medium or product including program instructions recorded thereon, may direct the data processing system 700 so as to facilitate the practice of the described method(s). It is understood that such apparatus and articles of manufacture, in addition to the described methods, all fall within the scope of the described embodiments.

In particular, the sequences of instruction which when executed cause the method described herein to be performed by the data processing system 700 can be contained in a data carrier product according to one embodiment of the invention. This data carrier product can be loaded into and run buy the data processing system 700. In addition, the sequences of instruction which when executed cause the method described herein to be performed by the data processing system 700 can be contained in a computer program or software product according to one embodiment of the invention. This computer program or software product can be loaded into and run by the data processing system 700. Moreover, the sequences of instructions which when executed cause the method described herein to be performed by the data processing system 700 can be contained in an integrated circuit product (e.g. hardware module or modules) which may include a coprocessor or memory according to one embodiment of the invention. This integrated circuit product can be installed in the data processing system 700.

The embodiments of the invention described herein are intended to be exemplary only. Accordingly, various alterations and/or modifications of detail may be made to these embodiments, all of which come within the scope of the invention.

What is claimed is:

1. A method for video encoding, comprising:
in respect of at least one video unit, selecting either (i) a set of predefined filters from among sets of predefined filters stored in a filter set table or (ii) a set of newly generated filters; and,
applying at least one filter of the selected set of filters to at least one reconstructed sample of the video unit.

2. The method of claim 1, wherein the set of predefined filters comprises a set of default filters.

3. The method of claim 1, wherein the set of predefined filters comprises a set of cached filters.

4. The method of claim 1, further comprising:
encoding a reference to an entry in the filter set table within a video unit header associated with the video unit.

5. The method of claim 4, wherein the reference to the entry in the filter set table is a parameter set reference.

6. The method of claim 4, wherein the video unit header is a slice header.

7. The method of claim 4, wherein the filter set table is distributed throughout a plurality of parameter sets stored in a parameter set table.

8. The method of claim 1, wherein the set of newly generated filters is encoded as at least a part of a parameter set.

9. The method of claim 1, wherein the set of newly generated filters is encoded in at least a part of a video unit header.

10. The method of claim 1, wherein at least one of the set of predefined filters or the set of newly generated filters comprises only one filter.

11. A method for video decoding, comprising:
in respect of at least one video unit, receiving a reference to either (i) a set of predefined filters or (ii) a set of newly generated filters; and,
applying at least one filter of the referenced set of filters to at least one decoded or reconstructed sample of the video unit.

12. The method of claim 11, wherein the set of predefined filters comprises a set of default filters.

13. The method of claim 11, wherein the set of predefined filters comprises a set of cached filters.

14. The method of claim 11, wherein the reference to a set of predefined filters is a parameter set reference from a slice header.

15. The method of claim 14, further comprising:
activating a parameter set comprising the referenced set of predefined filters.

16. The method of claim 11, wherein the set of newly generated filters is received as part of a parameter set.

17. The method of claim 11, wherein the set of newly generated filters is received as part of a video unit header.

18. The method of claim 11, wherein at least one of the set of predefined filters or the set of newly generated filters comprises only one filter.

19. A non-transitory computer readable media having computer executable instructions stored thereon for programming one or more processors to perform a method for video encoding, the method comprising:
in respect of at least one video unit, selecting either (i) a set of predefined filters from among sets of predefined filters stored in a filter set table or (ii) a set of newly generated filters; and,
applying at least one filter of the selected set of filters to at least one reconstructed sample of the video unit.

20. A non-transitory computer readable media having computer executable instructions stored thereon for programming one or more processors to perform a method for video decoding, the method comprising:
in respect of at least one video unit, receiving a reference to either (i) a set of predefined filters or (ii) a set of newly generated filters; and,
applying at least one filter of the referenced set of filters to at least one decoded or reconstructed sample of the video unit.
